(19) United States
(12) Patent Application Publication
(10) Pub. No.: US 2010/0017600 A1
(43) Pub. Date: Jan. 21, 2010

(54) SECURE NEIGHBOR CACHE PRELOAD

(75) Inventors: Peter Lepeska, Boston, MA (US); William B. Sebastian, Quincy, MA (US); Gary Price, Jamaica Plain, MA (US)

Correspondence Address: TOWNSEND AND TOWNSEND AND CREW LLP;VIASAT, INC. (CLIENT #017018), TWO EMBARCADERO CENTER, 8TH FLOOR, SAN FRANCISCO, CA, 94111, US

(73) Assignee: ViaSat, Inc., Carlsbad, CA (US)

(21) Appl. No.: 12/503,760

(22) Filed: Jul. 15, 2009

Related U.S. Application Data
(60) Provisional application No. 61/080,886, filed on Jul. 15, 2008.

(51) Int. Cl. H04L 9/00; G06F 15/16; H04L 29/06

(52) U.S. Cl. 713/163; 709/203; 713/168

(57) ABSTRACT

The present invention relates to methods, apparatus, and systems for implementing a secure neighbor cache preload. The method includes initiating a data transfer request. The data transfer request is associated with a sequence of bytes. Further, receiving bytes associated with the data transfer request. Further, the method includes storing the bytes in the client system's personal cache, and processing the data transfer request through a filtering system. The filtering system is configured to determine whether the sequence of bytes is to be relayed to the plurality of clients. Then, based on the data transfer request passing through the filtering system, echoing the sequence of bytes to the plurality of client systems within the LAN using an Internet protocol (IP) broadcast operation, and storing within each of the plurality of client systems' public caches at least a portion of the relayed sequence of bytes associated with the data transfer request.

### PRIORITY CLAIM

This application claims priority to U.S. Provisional Application No. 61/080,886, entitled METHODS AND SYSTEMS FOR IMPLEMENTING SECURE NEIGHBOR CACHE PRELOAD, filed on Jul. 15, 2008, which is incorporated by reference in its entirety for any and all purposes.

### FIELD OF THE INVENTION

The present invention relates, in general, to network acceleration and, more particularly, to implementing secure neighbor cache preloading.

### BACKGROUND

In current systems if an email with an attachment is sent to multiple clients on a subnet (or LAN), each of the clients would separately download the email and attachment from the server. Accordingly, resources are wasted and the network is unnecessarily burdened and slowed by multiple downloads of the same content. It is common in enterprise (and other) networks for multiple clients (and sometimes all clients) on the network to download the same content (e.g., an update, a corporate application, attachment, etc.). Hence, in order to better utilize network and system resources and provide acceleration for network communications, improvements in the art are needed.

### BRIEF SUMMARY

One embodiment is directed to a method of implementing a secure neighbor cache preload. The method includes initiating, at a client system within a local area network (LAN) which includes a plurality of clients, a data transfer request. The response to the data transfer request is associated with a sequence of bytes. The method further includes receiving, at the client system from a content server via a proxy server, the sequence of bytes associated with the data transfer request. The sequence of bytes may be encrypted by the proxy server, and one or more of the plurality of clients may be able to decrypt the sequence of bytes. The client systems may receive an encryption key from the proxy server and use that key to decrypt the sequence of bytes. Further, the method includes storing the sequence of bytes in the client system's personal cache, and processing the data transfer request through a filtering system.

The filtering system is configured to determine whether the sequence of bytes is to be relayed to the plurality of clients. The method further includes based on the data transfer request passing through the filtering system, echoing, at the client system, the sequence of bytes to the plurality of client systems within the LAN using an Internet protocol (IP) broadcast operation, and storing within each of the plurality of client systems' public caches at least a portion of the relayed sequence of bytes associated with the data transfer request.

Another embodiment is directed to a system for implementing a secure neighbor cache preload. The system includes a content server configured to transfer a sequence of bytes associated with a data transfer request, and a proxy server coupled with the content server. The proxy server is configured to retrieve the sequence of bytes associated with the data transfer request, and forward the sequence of bytes.

The system further includes a client system coupled with the proxy server. The client system configured to receive the sequence of bytes associated with the data transfer request from the proxy server, and process the sequence of bytes through a filtering system. The filtering system is configured to determine whether the sequence of bytes from the data transfer request is to be relayed, and based on the data transfer request passing through the filtering system, relay the sequence of bytes from the data transfer request using a LAN broadcast operation. The system further includes a plurality of client systems coupled with the client system, each having a shared cache. The plurality of client systems is configured to receive the relayed sequence of bytes from the client system, and store at least a portion of the relayed sequence of bytes in the shared caches.

In an alternative embodiment, a machine-readable medium is described. The machine-readable medium includes instructions for implementing a secure neighbor cache preload. The machine-readable medium includes instructions for initiating, at a client system within a local area network (LAN) which includes a plurality of clients, a data transfer request. The data transfer request is associated with a sequence of bytes. The machine-readable medium further includes instructions for receiving, at the client system from a content server via a proxy server, the sequences of bytes associated with the data transfer request. Further, the machine-readable medium includes instructions for storing the sequence of bytes in the client system's personal cache, and processing the data transfer request through a filtering system.

The filtering system is configured to determine whether the sequence of bytes is to be relayed to the plurality of clients. The machine-readable medium further includes instructions for, based on the data transfer request passing through the filtering system, echoing, at the client system, the sequence of bytes to the plurality of client systems within the LAN using a broadcast operation, and storing within each of the plurality of client systems' public caches at least a portion of the relayed sequence of bytes associated with the data transfer request.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a flow diagram illustrating a method of implementing secure neighbor cache preloading, according to one embodiment of the present invention.

FIG. 2 is a flow diagram illustrating a method of further implementing secure neighbor cache preloading, according to another embodiment of the present invention.

FIG. 3 is a flow diagram illustrating a method of implementing secure neighbor cache preloading, according to yet another embodiment of the present invention.

FIG. 4 is a block diagram illustrating a system for implementing secure neighbor cache preloading, according to one embodiment of the present invention.

FIG. 5 is a generalized schematic diagram illustrating a computer system, in accordance with various embodiments of the invention.

FIG. 6 is a block diagram illustrating a networked system of computers, which can be used in accordance with various embodiments of the invention.

FIG. 7 is a block diagram illustrating a satellite communications system, which can be used in accordance with various embodiments of the invention.

FIG. 8 is a block diagram illustrating a satellite gateway, which can be used in accordance with various embodiments of the invention.

FIG. 9 is a block diagram illustrating multiple satellite subscriber terminals, which can be used in accordance with various embodiments of the invention.

### DETAILED DESCRIPTION OF THE INVENTION

The ensuing description provides exemplary embodiment(s) only and is not intended to limit the scope, applicability or configuration of the disclosure. Rather, the ensuing description of the exemplary embodiment(s) will provide those skilled in the art with an enabling description for implementing an exemplary embodiment. It should be understood that various changes may be made in the function and arrangement of elements without departing from the spirit and scope as set forth in the appended claims.

Aspects of the disclosure relate to secure neighbor cache and passive broadcast preloading. In one embodiment, these network acceleration techniques may be applied to a network configuration (e.g., a local area network (LAN), etc.) which includes at least two clients, at least one proxy server, and at least one content server. For example, a data transfer request is received at the proxy server from one of the client systems. In many instances the data or even a portion of the data (i.e., a sequence of bytes from the data) may subsequently be requested by another client system within the LAN. Accordingly, it would be advantageous for each client within the LAN to store a copy of the transferred data within the client's shared byte cache. In other words, a partial synchronization of shared byte caches among the client systems is maintained. In one embodiment, it may not be a complete synchronization because of the fact that the overhead and added traffic of each client sending synchronization messages and data between the proxy server, and between the proxy server and the other client systems would outweigh any usefulness achieved from the complete synchronization. However, in alternative embodiments a complete synchronization may be executed.

Hence, in order to remedy this problem, each instance a data transfer is initiated by a client within the LAN, the client will execute an Internet protocol (IP) broadcast or multicast transfer of the data to each of the active clients within the LAN. Each of the active clients then stores the received data in their respective shared byte caches. Therefore, if the stored data is subsequently requested by another client or other clients, then the requesting client can check its shared cache, and if the data is stored within the shared cache, the requesting client can retrieve the data from its shared byte cache. Thus, reducing the need for the requesting client to retrieve the data from the content server and providing a reduction in network traffic congestion and round trips.

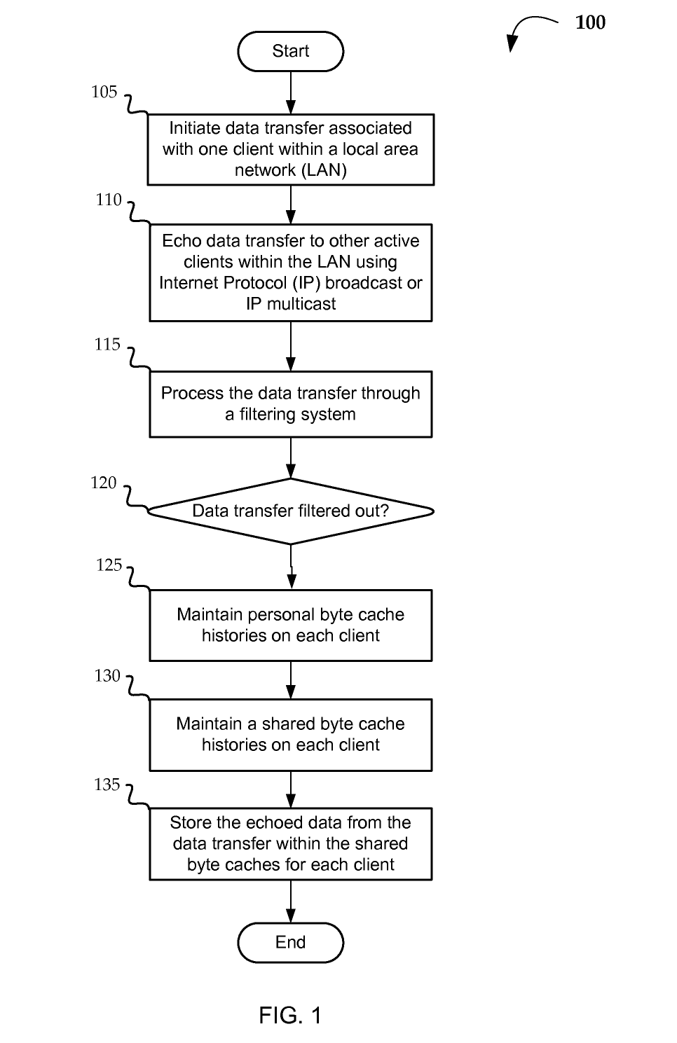

Turning now to FIG. 1, which illustrates a method 100 for implementing secure neighbor cache preload via broadcast updates, according to embodiments of the present invention. At process block 105, a data transfer request may be initiated at, for example, a client system within a LAN or subnet. The data transfer request may be a request for an email attachment, a file from a content server, a text document, an image file, etc. Merely by way of example, the data transfer request may be for an email attachment from an email message which is transmitted to a client system within the LAN. In such a situation, the proxy server would initially retrieve the attachment file from the content server (e.g., a mail server) and then transmit the attachment file to the requesting client.

At process block 110, the data, or in this particular example, the email attachment, may be transmitted to each of the active client systems within the LAN in addition to the requesting client system. In one embodiment, the client system receiving the data would initiate an IP broadcast or IP multicast operation in order to transmit the email attachment to each of the other active client systems within the LAN or subnet. One of the benefits to using broadcast or multicast is the reduction in network traffic within the LAN. For example, if the rate of transfer of data sent to neighbor clients is 10 Mbps and there are N neighbor clients, then multicast and/or broadcast utilizes 10 Mbps of a 1 Gbps of a typical LAN's bandwidth, as opposed to 10*N. In other words, instead of each client system sending a message to the proxy server upon receipt of new content, and then the proxy server transmitting the new content to the other active client systems; each of the active client systems can receive the new content shortly after the requesting client, without additional messages being transmitted. The client system simply “echoes” the data (i.e., email attachment) using IP broadcast (or multicast) to each active client within the LAN, and accordingly, each active client on the LAN will receive the data at approximately the same time as the requesting client. (i.e., no additional synchronization, or similar messages are required).

In an alternative embodiment, instead of the receiving client systems initiating the broadcast message, the proxy server may initiate the broadcast message. Hence, as the requested data is received by the proxy server, the proxy server can send the requested data to the requesting client using IP broadcast. Accordingly, instead of only the requesting client receiving the data, each of the active clients on the LAN would also receive the data. Accordingly, this allows, for example, an enterprise application to pre-position content in the shared caches on each client system without having to separately transmit the data to each client. This provides a significant bandwidth savings.

Furthermore, on each occasion that a client system within the LAN requests a file transfer (e.g., uploads or downloads data), the file transfer will be relayed (or transmitted using broadcast or multicast) such that each client will have a byte cache partially synchronized with other client systems during the time in which each client system is active. In this situation, imagine that when the requesting client system initially began downloading the email attachment, five other client systems were active within the LAN, and therefore, following the broadcast of the attachment, the five other client systems also begin to retrieve the attachment from the requesting client. During the retrieval, two of the client systems disconnected from the LAN and one additional client system initiated a connection. The two disconnected client systems would only have a portion of the bytes of the email attachment, the newly connected client system would begin retrieving the email attachment at some point in the middle of the file (also only having a potion of the email attachment), and the other three client systems would have the entire email attachment, thus, each of the clients storing the retrieved attachment (or part of the attachment) in each of their shared caches. Therefore, the client systems are partially synchronized as opposed to completely synchronized.

In a further embodiment, an additional benefit to the client systems only being partially synchronized is that there is no need, for example, for the proxy server to be concerned with receiving acknowledgment messages from individual clients. In other words, the client systems can connect and disconnect from the LAN without having to be concerned with indicating acknowledgement of receipt of the broadcasted data. Such a system allows for passively receiving the data without unnecessarily burdening the network, the client systems, or the proxy server. Furthermore, even without transmitting acknowledgments, the proxy server can still be kept apprised of the content stored on each client system by instructing each client system to transmit an update message to the proxy server each time a client system connects to the LAN. Accordingly, the proxy server has the option of being made aware of each client system's stored content within their byte cache each time a client system reconnects to the LAN, thus providing an accurate updated view of each client's stored content to the proxy server.

At process block 115, the content associated with the data transfer may be processed through a filtering system. In one embodiment, the filtering system may be based on a number of factors. For example, the filtering system may filter content based on application or application type which is requesting the data (e.g., a mail client, editing software, Internet browser, file manager, etc.), the process name associated with the data request, the protocol associated with the request (e.g., file transfer protocol (FTP), hyper text transfer protocol (HTTP), simple message transfer protocol (SMTP), etc.), the destination port, the destination IP address, the host name, whether the data is encrypted or not, etc.

For example, company A operating a LAN may want to filter out any HTTP content from being broadcast to the entire LAN. Alternatively, company A may have an enterprise software suite which manages work product documents within the LAN, as such company A may want to not filter content associated with that enterprise software suite. Hence, depending on the filtering criteria set for a given LAN, certain content may be filtered out of being broadcast to the other clients within the LAN, whereas other content may not be filtered out.

Additionally, certain threshold values may be established for the filtering system. For example, a file size threshold (e.g., no files grater than 100 megabytes are to be broadcast) may be used to avoid downloading files which are too large and could potentially overload the network. Such a threshold may also prevent the shared byte caches of the client systems within the LAN from being flushed by an overly large file being downloaded which may not have any significant value to the rest of the network. Furthermore, for security or other reasons, the proxy server may filter any encrypted content from being broadcasted. Alternately, each individual client system may be able to configure filtering. For example, a client may not want to receive any broadcasted content, or may want to only receive broadcasted content below a certain size, or from certain applications, etc.

At decision block 120, a determination is made whether the data transfer has been filtered out. If the data transfer is filtered out, then the requesting client simply receives the content without sending a broadcast message out to the other client systems within the LAN. However, if the data transfer is not filtered out (i.e., the content associated with the data transfer meets the filtering criteria), then after the requesting client has received the content, the requesting client would send out a broadcast transmission of the content to each of the active client systems. At process block 125, the requesting client system would store the content in its personal byte cache. Furthermore, the personal byte cache histories are maintained.

In one embodiment, each client system would maintain a personal and a shared byte cache (process block 130). Hence, the content received from the broadcast would be stored in each of the client systems' shared caches. For example, each client may have a single circular buffer which is logically partitioned into two caches, in which one cache is for personal content and the other cache is for shared content. Accordingly, each client is able to protect the content which they have personally downloaded, which is typically more valuable to the client than publicly downloaded content. In one embodiment, each client may have a one gigabyte personal cache and a one gigabyte shared cache; however, other values may be assigned either cache. Additionally, the proxy server and/or each client may be able to configure the two cache sizes. For example, a certain client may want to have one and one-half gigabytes for a personal cache and one-half a gigabyte for a shared cache, and so forth. Further, each of the caches may be least recently used (LRU) caches.

In a further embodiment, the broadcasted traffic within the LAN may be encrypted. For example, each client system may be given an encryption key that is associated with the encrypted data during the handshake that occurs each time the client system connects to the proxy server. Thus the client systems do not need to maintain the encryption key in storage and instead are able to maintain the key in memory. In one embodiment, the data encryption key would be the same for all data within the LAN. Accordingly, the broadcasted content can be encrypted using the “LAN's key” and each client system is able to decrypt the content. In addition, an infrastructure may be maintained which allows for the proxy server to maintaining a LAN or subnet to provide the client systems with the session key upon connecting to the LAN or subnet. Thus, the encryption can be maintained for the entire LAN or subnet without any special considerations for each individual client system.

Furthermore, at process block 135, each of the client systems within the LAN stores the relayed content within their shared byte caches. Hence, such relayed content is available to the client system storing the content in its shared cache for retrieval by the storing client system of subsequent data transfer requests.

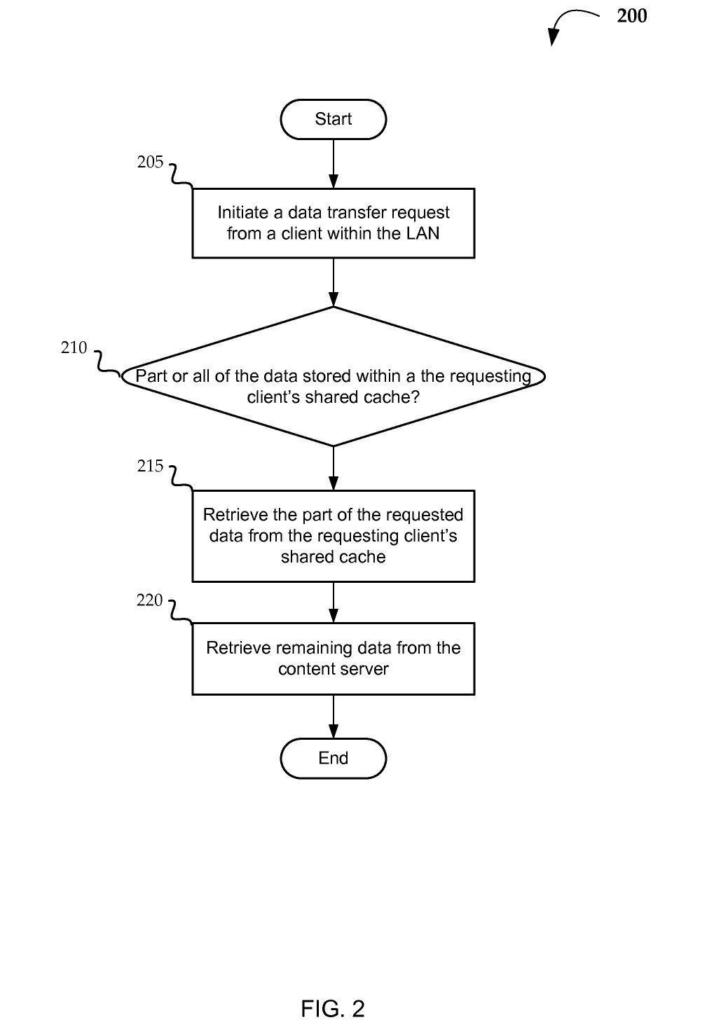

Referring now to FIG. 2, which illustrates a method 200 for utilizing the stored content on a client system within a LAN. At process block 205, a data transfer request may be initiated by a client system within the LAN. As discussed above, the request may be for any file type and initiated by any type of application. In response to the data transfer request, the requesting client system may determine if part or all of the bytes associated with the data transfer request are stored within the requesting client system's shared cache (decision block 210). For example, a given client system may have a number of complete files and a number of partial files stored in their shared cache which were previously obtained from broadcasted data from other client systems. Accordingly, if the data is present, the requesting client system would retrieve the requested data from its shared cache. For example, referring back to the above example, assume that the requesting client was active while the initially requesting client was echoing the email attachment. Therefore, the current requesting client would have a copy of the email attachment already stored in its shared byte cache (i.e., from the relayed data). Hence, instead of downloading the email attachment again from the content server, the current requesting client can simply access its shared cache to retrieve the email attachment (process block 225). Similarly, this operation could be used for any type of content and/or data (i.e., other than an email attachment, which was used merely by way of example).

At process block 230, once the current requesting client retrieves the data from its shared cache, the current requesting client determines whether additional bytes are still needed. For example, the current requesting client may have only been active for half of the email attachment and so only half of the email attachment is able to be retrieved from the current requesting client's shared cache. Accordingly, the requesting client would need to retrieve the remaining bytes of the email attachment from the content server.

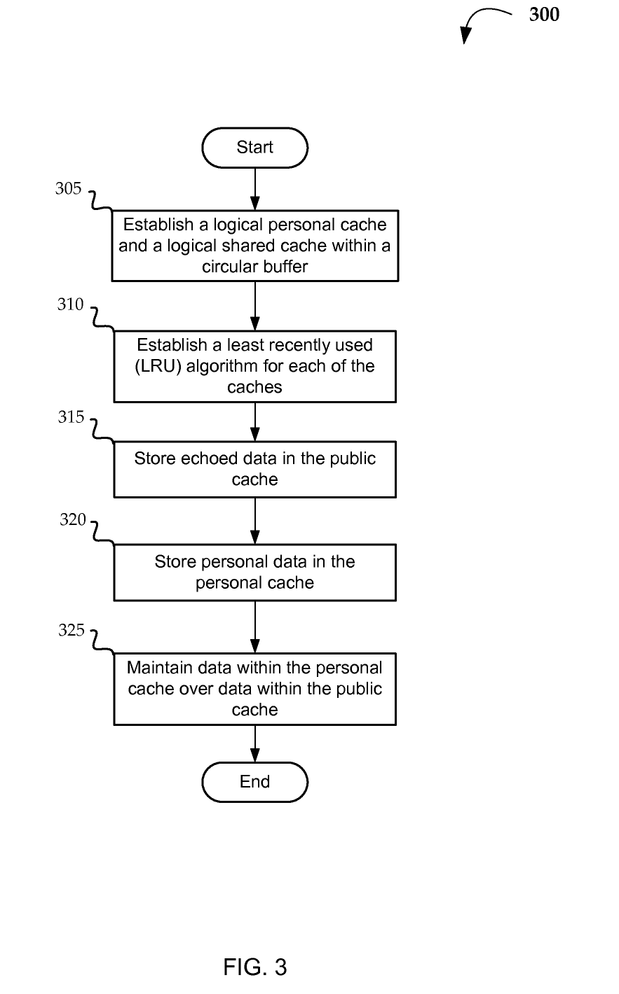

Referring now to FIG. 3, which illustrates a method 300 for maintaining a personal and shared byte cache within a client system. At process block 305, a logical personal byte cache and a logical shared byte cache are established within a LRU circular buffer. The personal cache would be used to store cached data which was specifically downloaded by the client system in which personal byte cache is stored. Further, the shared byte cache is used to store data which is received by a client system from broadcasted data transfers. In an alternative embodiment, the two caches may be stored in two separate buffers, and the caches may be any suitable data structures. The two caches may be separated within the single buffer by tagging, flagging, etc. the data stored within the buffer. The personal data flagged with a personal data flag and the shared data flagged with a shared data flag. Nonetheless, other distinguishing methods may be used.

At process block 310, a LRU algorithm may be established in order to properly maintain the data stored within the two caches. For example, the LRU algorithm may be configured to place the most recently added data at the front of the cache, and allow the oldest data to be removed from the cache. Hence, the newest data consistently remains in the cache, while the oldest data is removed (i.e., erased by the newer data). Nonetheless, any other appropriate LRU algorithm may be used.

As discussed above, any relayed data received by a client system from a broadcasted data transfer is stored within the public cache (process block 315). Furthermore, any data received by a client system, from a data transfer which was personally initiated by the client system is stored within the client system's personal cache (process block 320). Thus, the caches are maintained separately to ensure that each client system's personally cached data is not overwritten by less important (less important to the client system specifically) shared cache data. Accordingly, the personal cache data is maintained at a higher priority than the shared cache data (process block 325).

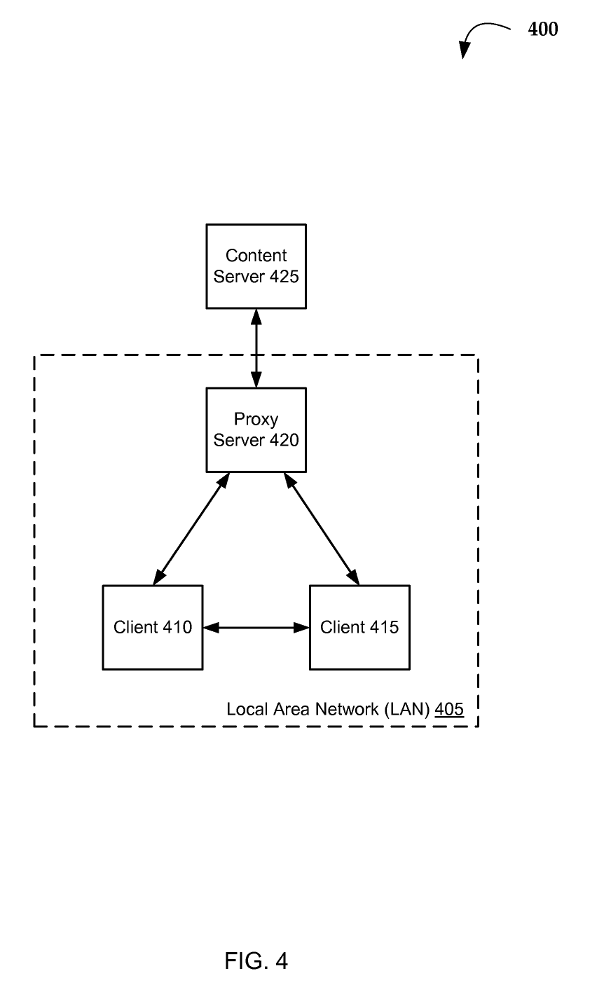

FIG. 4 illustrates a system 400 for implementing neighbor caching according to embodiments of the present invention. In one embodiment, system 400 may include a LAN 405. LAN 405 may include clients 410 and 415 within the network. Alternatively, LAN 405 may include any number of clients; however, merely for explanatory purposes, only two client systems are shown. System 400 may further include a proxy server 420 coupled with clients 410 and 415, as well as a content server 425 coupled with proxy server 420. In one embodiment, content server 425 may be an email server, a file server, a web server, etc.

In a further embodiment, client 410 may initiate a data transfer request. The request may be, for example, a request to download an image file from a webpage initiated through client 410's web browser. Nonetheless, other applications and other file types may be included in this request or subsequent requests. Accordingly, proxy server 420 may intercept the request and retrieve the content from content server 425 on behalf of client 410. In one embodiment, in accordance with aspects of the present invention, proxy server 420 may then transmit the requested content to client 410. Client 410 may then use IP broadcast or IP multicast to transmit the content to client 415 (i.e., the other active client systems within the LAN). Thus, instead of only client 410 receiving the content, client 415 also receives the content. In other words, after client 410 receives the content and store the content in its personal cache, client 410 then broadcasts (or echoes) the content to client 415 to be stored in client 415's shared cache.

Thus, since client 410 initially requested the content, client 410 would store the content in its personal byte cache, whereas since client 415 received the content through a broadcast transfer, client 415 would store the content in its shared byte cache. Accordingly, both client 410 and 415 have copies of the content stored within their byte caches, therefore, when client 415 requests the same image file, client 415 can simply retrieve the image file from its shared cache as opposed to retrieving the image file from content server 425 via proxy server 420. Hence, client 420 can retrieve the content at a faster rate, while at the same time reducing network traffic and round trips.

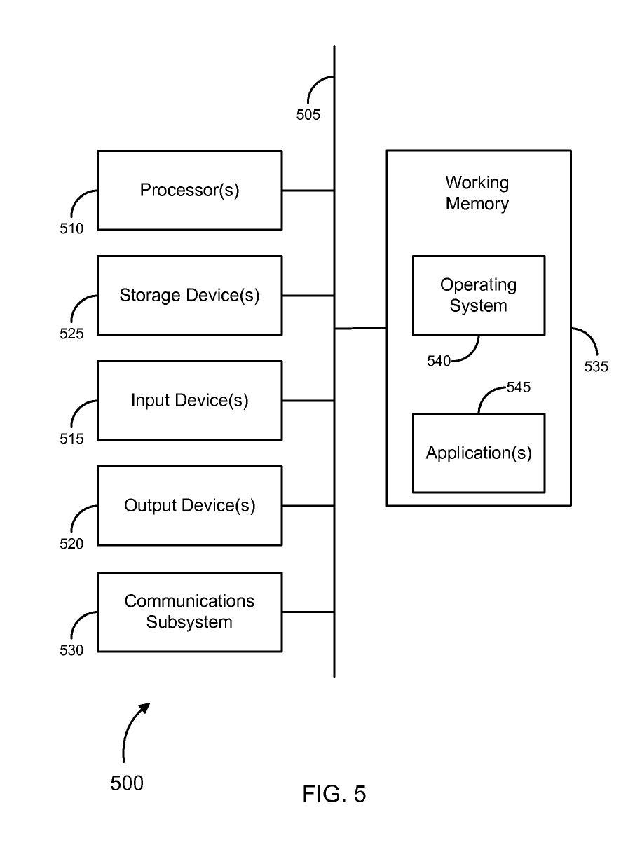

FIG. 5 provides a schematic illustration of one embodiment of a computer system 500 that can perform the methods of the invention, as described herein, and/or can function, for example, as any part of clients 410 or 415, content server 425, etc. of FIG. 4. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements can include one or more processors 510, including without limitation one or more general-purpose processors and/or one or more special-purpose processors (such as digital signal processing chips, graphics acceleration chips, and/or the like); one or more input devices 515, which can include without limitation a mouse, a keyboard and/or the like; and one or more output devices 520, which can include without limitation a display device, a printer and/or the like.

The computer system 500 may further include (and/or be in communication with) one or more storage devices 525, which can comprise, without limitation, local and/or network accessible storage and/or can include, without limitation, a disk drive, a drive array, an optical storage device, a solid-state storage device such as a random access memory (“RAM”) and/or a read-only memory (“ROM”), which can be programmable, flash-updateable and/or the like. The computer system 500 might also include a communications subsystem 530, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 530 may permit data to be exchanged with a network (such as the network described below, to name one example), and/or any other devices described herein. In many embodiments, the computer system 500 will further comprise a working memory 535, which can include a RAM or ROM device, as described above.

The computer system 500 also can comprise software elements, shown as being currently located within the working memory 535, including an operating system 540 and/or other code, such as one or more application programs 545, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer-readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 500) to perform methods of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another machine-readable medium, such as one or more of the storage device(s) 525. Merely by way of example, execution of the sequences of instructions contained in the working memory 535 might cause the processor(s) 510 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 500, various machine-readable media might be involved in providing instructions/code to processor(s) 510 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 525. Volatile media includes, without limitation, dynamic memory, such as the working memory 535. Transmission media includes coaxial cables, copper wire and fiber optics, including the wires that comprise the bus 505, as well as the various components of the communication subsystem 530 (and/or the media by which the communications subsystem 530 provides communication with other devices). Hence, transmission media can also take the form of waves (including without limitation, radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc., carried by the signals) to the working memory 535, from which the processor(s) 505 retrieves and executes the instructions. The instructions received by the working memory 535 may optionally be stored on a storage device 525 either before or after execution by the processor(s) 510.

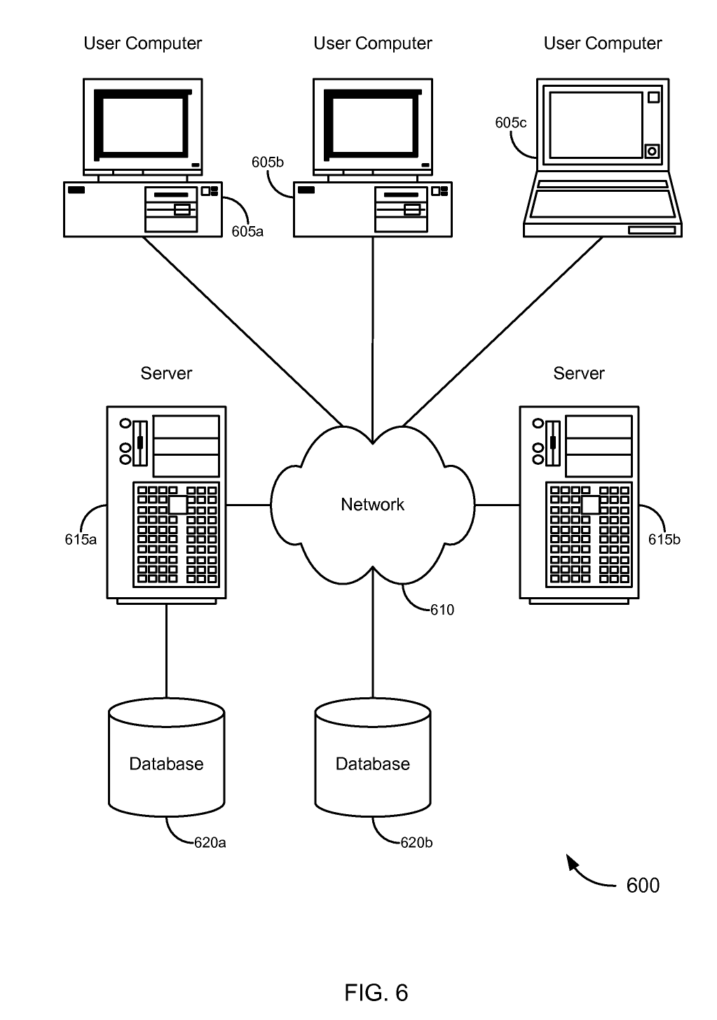

Merely by way of example, FIG. 6 illustrates a schematic diagram of a system 600 that can be used in accordance with one set of embodiments. The system 600 can include one or more user computers 605. The user computers 605 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially available UNIX™ or UNIX-like operating systems. These user computers 605 can also have any of a variety of applications, including one or more applications configured to perform methods of the invention, as well as one or more office applications, database client and/or server applications, and web browser applications. Alternatively, the user computers 605 can be any other electronic device, such as a thin-client computer, Internet-enabled mobile telephone, and/or personal digital assistant (PDA), capable of communicating via a network (e.g., the network 610 described below) and/or displaying and navigating web pages or other types of electronic documents. Although the exemplary system 600 is shown with three user computers 605, any number of user computers can be supported.

Certain embodiments of the invention operate in a networked environment, which can include a network 610. The network 610 can be any type of network familiar to those skilled in the art that can support data communications using any of a variety of commercially available protocols, including without limitation TCP/IP, SNA, IPX, AppleTalk, and the like. Merely by way of example, the network 610 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 615. Each of the server computers 615 may be configured with an operating system, including without limitation any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 may be a web server, which can be used, merely by way of example, to process requests for web pages or other electronic documents from user computers 605. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 605 to perform methods of the invention.

The server computers 615, in some embodiments, might include one or more application servers, which can include one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configurator, database clients, API clients, web browsers, etc.) running on a user computer 605 and/or another server 615. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 605 via a web server (as described above, for example). Similarly, a web server might receive web page requests and/or input data from a user computer 605 and/or forward the web page requests and/or input data to an application server. In some cases a web server may be integrated with an application server.

In accordance with further embodiments, one or more servers 615 can function as a file server and/or can include one or more of the files (e.g., application code, data files, etc.) necessary to implement methods of the invention incorporated by an application running on a user computer 605 and/or another server 615. Alternatively, as those skilled in the art will appreciate, a file server can include all necessary files, allowing such an application to be invoked remotely by a user computer 605 and/or server 615. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620. The location of the database(s) 620 is discretionary: merely by way of example, a database 620a might reside on a storage medium local to (and/or resident in) a server 615a (and/or a user computer 605). Alternatively, a database 620b can be remote from any or all of the computers 605, 615, so long as the database can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, that is adapted to store, update, and retrieve data in response to SQL-formatted commands. The database might be controlled and/or maintained by a database server, as described above, for example.

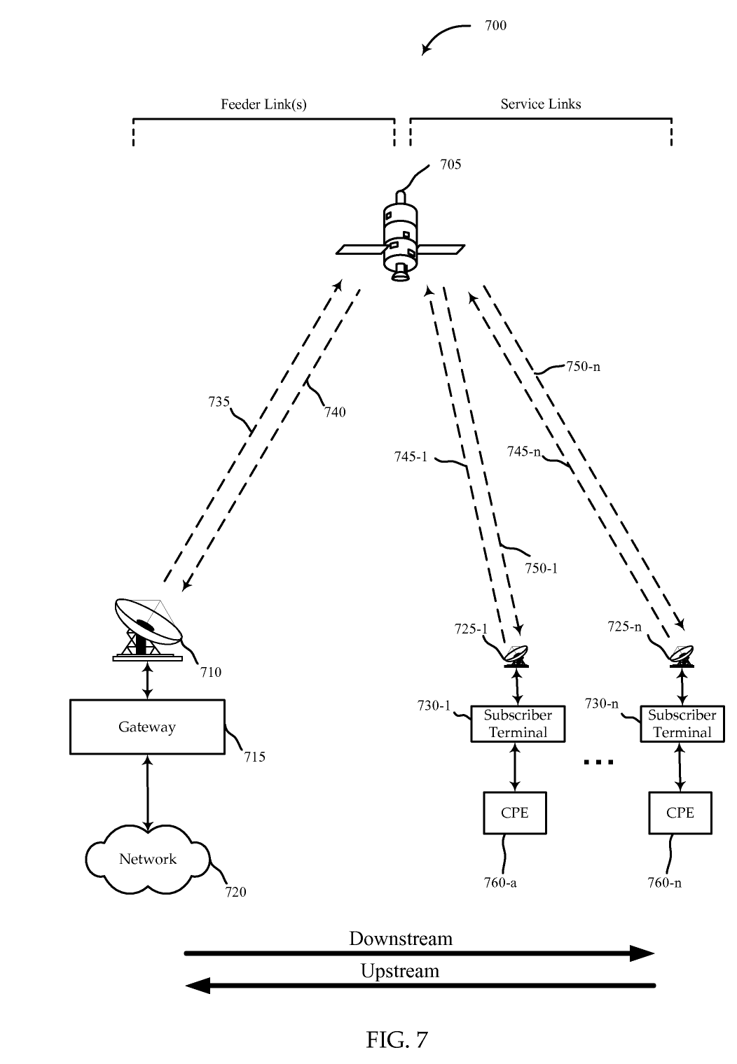

Referring now to FIG. 7, a module diagram is shown of a satellite communications system 700 for use with various embodiments of the invention. The satellite communications system 700 includes a network 720, such as the Internet, interfaced with a gateway 715 that is configured to communicate with one or more subscriber terminals 730, via a satellite 705. A gateway 715 is sometimes referred to as a hub or ground station. Subscriber terminals 730 are sometimes called modems, satellite modems, or user terminals. As noted above, although the communications system 700 is illustrated as a geostationary satellite 705 based communication system, it should be noted that various embodiments described herein are not limited to use in geostationary satellite-based systems; for example, some embodiments could be low earth orbit (“LEO”) satellite-based systems or aerial payloads not in orbit and held aloft by planes, blimps, weather balloons, etc. Other embodiments could have a number of satellites instead of just one.

The network 720 may be any type of network and can include, for example, the Internet, an Internet protocol (“IP”) network, an intranet, a wide-area network (“WAN”), a local-area network (“LAN”), a virtual private network (“VPN”), the Public Switched Telephone Network (“PSTN”), and/or any other type of network supporting data communication between devices described herein, in different embodiments. A network 720 may include both wired and wireless connections, including optical links. As illustrated in a number of embodiments, the network 720 may connect the gateway 715 with other gateways (not shown), which are also in communication with the satellite 705.

The gateway 715 provides an interface between the network 720 and the satellite 705. The gateway 715 may be configured to receive data and information directed to one or more subscriber terminals 730, and can format the data and information for delivery to the respective destination device via the satellite 705. Similarly, the gateway 715 may be configured to receive signals from the satellite 705 (e.g., from one or more subscriber terminals 730) directed to a destination in the network 720, and can process the received signals for transmission along the network 720.

A device (not shown) connected to the network 720 may communicate with one or more subscriber terminals 730. Data and information, for example IP datagrams, may be sent from a device in the network 720 to the gateway 715. It will be appreciated that the network 720 may be in further communication with a number of different types of providers, including content providers, application providers, service providers, etc. Further, in various embodiments, the providers may communicate content with the satellite communication system 700 through the network 720, or through other components of the system (e.g., directly through the gateway 715).

The gateway 715 may format frames in accordance with a physical layer definition for transmission to the satellite 705. A variety of physical layer transmission modulation and coding techniques may be used with certain embodiments of the invention, including those defined with the DVB-S2 standard. The link 735 from the gateway 715 to the satellite 705 may be referred to hereinafter as the downstream uplink 735. The gateway 715 uses the antenna 710 to transmit the content (e.g., via signals) to the satellite 705. In one embodiment, the antenna 710 comprises a parabolic reflector with high directivity in the direction of the satellite and low directivity in other directions. The antenna 710 may comprise a variety of alternative configurations and include operating features such as high isolation between orthogonal polarizations, high efficiency in the operational frequency bands, and low noise.

In one embodiment, a geostationary satellite 705 is configured to receive the signals from the location of antenna 710 and within the frequency band and specific polarization transmitted. The satellite 705 may, for example, use a reflector antenna, lens antenna, array antenna, active antenna, or other mechanism known in the art for reception of such signals. The satellite 705 may process the signals received from the gateway 715 and forward the signal from the gateway 715 containing the MAC frame to one or more subscriber terminals 730. In one embodiment, the satellite 705 operates in a multi-beam mode, transmitting a number of narrow beams, each directed at a different region of the earth, allowing for frequency re-use with a multicolor beam pattern.

With such a multibeam satellite 705, there may be any number of different signal switching configurations on the satellite 705, allowing signals from a single gateway 715 to be switched between different spot beams. In one embodiment, the satellite 705 may be configured as a “bent pipe” satellite, wherein the satellite may frequency-convert the received carrier signals before retransmitting these signals to their destination, but otherwise perform little or no other processing on the contents of the signals. There could be a single carrier signal for each service spot beam or multiple carriers in different embodiments. Similarly, single or multiple carrier signals could be used for the feeder spot beams. A variety of physical layer transmission modulation and coding techniques may be used by the satellite 705 in accordance with certain embodiments of the invention, including those defined with the DVB-S2 standard. For other embodiments, a number of configurations are possible (e.g., using LEO satellites, or using a mesh network instead of a star network), as will be evident to those skilled in the art.

The service signals transmitted from the satellite 705 may be received by one or more subscriber terminals 730, via the respective subscriber antenna 725. In one embodiment, the subscriber antenna 725 and terminal 730 together comprise a very small aperture terminal (“VSAT”), with the antenna 725 measuring approximately 0.6 meters in diameter and having approximately 2 watts of power. In other embodiments, a variety of other types of subscriber antennae 725 may be used at the subscriber terminal 730 to receive the signal from the satellite 705. The link 750 from the satellite 705 to the subscriber terminals 730 may be referred to hereinafter as the downstream downlink 750. Each of the subscriber terminals 730 may comprise a single user terminal or, alternatively, comprise a hub or router (not pictured) that is coupled to multiple user terminals.

In some embodiments, some or all of the subscriber terminals 730 are connected to consumer premises equipment (“CPE”) 760. CPE may include, for example, computers, local area networks, Internet appliances, wireless networks, etc. A subscriber terminal 730, for example 730-a, may transmit data and information to a network 720 destination via the satellite 705. The subscriber terminal 730 transmits the signals via the upstream uplink 745-a to the satellite 705 using the subscriber antenna 725-a. The link from the satellite 705 to the gateway 715 may be referred to hereinafter as the upstream downlink 740.

In various embodiments, one or more of the satellite links (e.g., 735, 740, 745, and/or 750) are capable of communicating using one or more communication schemes. In various embodiments, the communication schemes may be the same or different for different links. The communication schemes may include different types of coding and modulation schemes. For example, various satellite links may communicate using physical layer transmission modulation and coding techniques, adaptive coding and modulation schemes, etc. The communication schemes may also use one or more different types of multiplexing schemes, including Multi-Frequency Time-Division Multiple Access (“MF-TDMA”), Time Division Multiple Access (“TDMA”), Frequency Division Multiple Access (“FDMA”), Orthogonal Frequency Division Multiple Access (“OFDMA”), Code Division Multiple Access (“CDMA”), or any number of hybrid or other schemes known in the art.

In a given satellite spot beam, all customers serviced by the spot beam may be capable of receiving all the content traversing the spot beam by virtue of the fact that the satellite communications system 700 employs wireless communications via various antennae (e.g., 710 and 725). However, some of the content may not be intended for receipt by certain customers. As such, the satellite communications system 700 may use various techniques to “direct” content to a subscriber or group of subscribers. For example, the content may be tagged (e.g., using packet header information according to a transmission protocol) with a certain destination identifier (e.g., an IP address) or use different modcode points. Each subscriber terminal 730 may then be adapted to handle the received data according to the tags. For example, content destined for a particular subscriber terminal 730 may be passed on to its respective CPE 760, while content not destined for the subscriber terminal 730 may be ignored. In some cases, the subscriber terminal 730 caches information not destined for the associated CPE 760 for use if the information is later found to be useful in avoiding traffic over the satellite link.

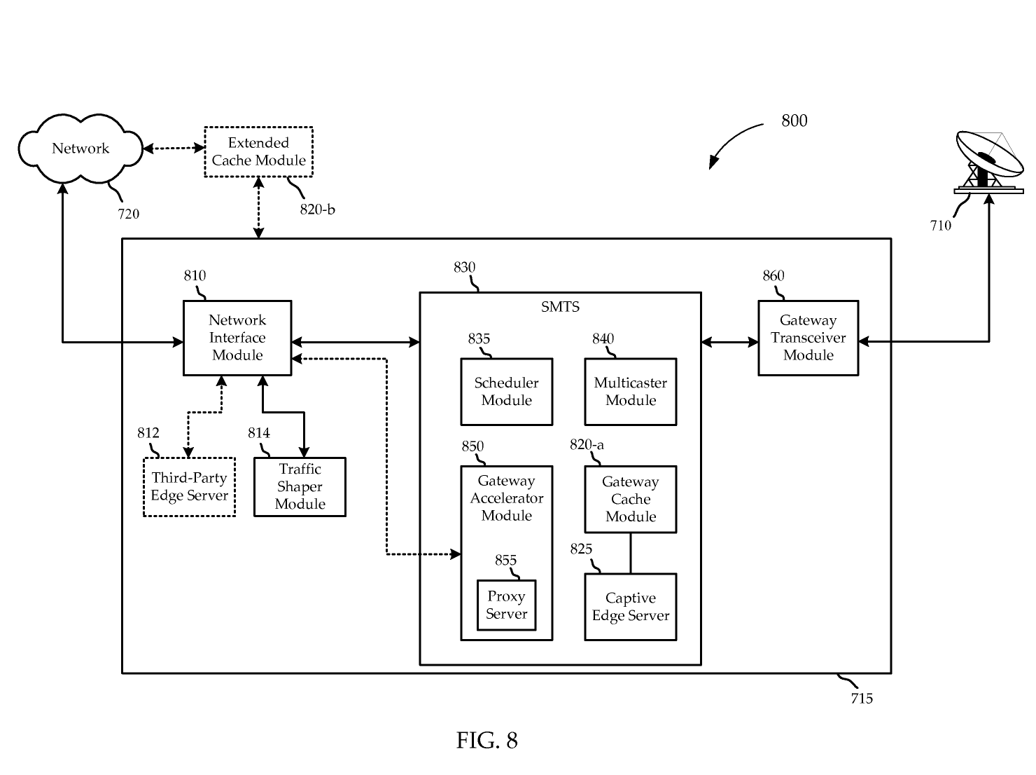

It will be appreciated that many embodiments of gateways are possible for use in embodiments of communication systems, like the satellite communication system 700 of FIG. 7. FIG. 8 shows a simplified block diagram 800 illustrating an embodiment of a gateway 715 coupled between the network 720 and an antenna 710, according to various embodiments of the invention. The gateway 715 has a number of components, including a network interface module 810, a satellite modem termination system (“SMTS”) 830, and a gateway transceiver module 860.

Components of the gateway 715 may be implemented, in whole or in part, in hardware. Thus, they may comprise one, or more, Application Specific Integrated Circuits (“ASICs”) adapted to perform a subset of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (“FPGAs”) and other Semi-Custom ICs), which may be programmed in any manner known in the art. Each may also be implemented, in whole or in part, with instructions embodied in a computer-readable medium, formatted to be executed by one or more general or application specific controllers.

Embodiments of the gateway 715 receive data from the network 720 (e.g., the network 720 of FIG. 7), including data destined for one or more subscribers in a spot beam. The data is received at the network interface module 810, which includes one or more components for interfacing with the network 720. For example, the network interface module 810 includes a network switch and a router.

In some embodiments, the network interface module 810 interfaces with other modules, including a third-party edge server 812 and/or a traffic shaper module 814. The third-party edge server 812 may be adapted to mirror content (e.g., implementing transparent mirroring, like would be performed in a point of presence (“POP”) of a content delivery network (“CDN”)) to the gateway 715. For example, the third-party edge server 812 may facilitate contractual relationships between content providers and service providers to move content closer to subscribers in the satellite communication network 700. The traffic shaper module 814 controls traffic from the network 720 through the gateway 715, for example, to help optimize performance of the satellite communication system 700 (e.g., by reducing latency, increasing effective bandwidth, etc.). In one embodiment, the traffic shaper module 814 delays packets in a traffic stream to conform to a predetermined traffic profile.

Traffic is passed from the network interface module 810 to the SMTS 830 to be handled by one or more of its component modules. In some embodiments, the SMTS 830 includes a scheduler module 835, a multicaster module 840, a gateway accelerator module 850, a gateway cache module 820-a, and/or a captive edge server 825. Embodiments of the scheduler module 835 are configured to provide various functions relating to scheduling the links of the satellite communication system 700 handled by the gateway 715. For example, the scheduler module 835 may manage link bandwidth by scheduling license grants within a spot beam. Embodiments of the multicaster module 840 are configured to provide various functions relating to multicasting of data over the links of the satellite communication system 700. For example, the multicaster module 840 may determine whether data is unicast or multicast to one or more subscribers. In some embodiments, the multicaster module 840 and/or scheduler module 835 contribute to determinations of what modcodes to use, whether data should or should not be sent as a function of data cached at destination subscriber terminals 730, how to handle certain types of encryption, etc.

Embodiments of the gateway accelerator module 850 provide various types of application, WAN/LAN, and/or other acceleration functionality. In one embodiment, the gateway accelerator module 850 implements functionality of AcceleNet applications from Intelligent Compression Technologies, Inc. (“ICT”), a division of ViaSat, Inc. This functionality may be used to exploit information from application layers of the protocol stack (e.g., layers 4-8 of the IP stack) through use of software or firmware operating in the subscriber terminal 730 and/or CPE 760.

In some embodiments, the gateway accelerator module 850 is adapted to provide high payload compression. For example, the gateway accelerator module 850 may compress payload such that over 85% of upload traffic when browsing the web is being used by transport management, rather than payload data. In other embodiments, functionality of the gateway accelerator module 850 is closely integrated with the satellite link through components of the SMTS 830 to reduce upload bandwidth requirements and/or to more efficiently schedule to satellite link (e.g., by communicating with the scheduler module 835). For example, the link layer may be used to determine whether packets are successfully delivered, and those packets can be tied more closely with the content they supported through application layer information. In certain embodiments, these and/or other functions of the gateway accelerator module 850 are provided by a proxy server 855 resident on (e.g., or in communication with) the gateway accelerator module 850.

In some embodiments, functionality of the SMTS 830 is provided through the gateway cache module 820. Embodiments of the gateway cache module 820 include any useful type of memory store for various types of functionality of the gateway 715. For example, the gateway cache module 820 may include volatile or non-volatile storage, servers, files, queues, etc. Further, in certain embodiments, storage functionality and/or capacity is shared between an integrated (e.g., on-board) gateway cache module 820-a and an extended (e.g., off-board) cache module 820-b. For example, the extended cache module 820-b may be accessible by the gateway 715 via the network 720.

In certain embodiments, the gateway cache module 820 is in communication with the captive edge server 825. In some embodiments, the captive edge server 825 provides functionality similar to that of the third-party edge server 812, including content mirroring. For example, the captive edge server 825 may facilitate different contractual relationships from those of the third-party edge server 812 (e.g., between the gateway 715 provider and various content providers).

It will be appreciated that the SMTS 830 may provide many different types of functionality. For example, embodiments of the SMTS 830 oversee a variety of decoding, interleaving, decryption, and unscrambling techniques. The SMTS 830 may also manage functions applicable to the communication of content downstream through the satellite 705 to one or more subscriber terminals 730. In certain embodiments, some or all of these downstream communication functions are handled by the gateway transceiver module 860.

Embodiments of the gateway transceiver module 860 encode and/or modulate data, using one or more error correction techniques, adaptive encoding techniques, baseband encapsulation, frame creation, etc. (e.g., using various modcodes, lookup tables, etc.). Other functions may also be performed by these components (e.g., by the SMTS 830), including upconverting, amplifying, filtering, tuning, tracking, etc. The gateway transceiver module 860 communicates data to one or more antennae 710 for transmission via the satellite 705 to the subscriber terminals 730.

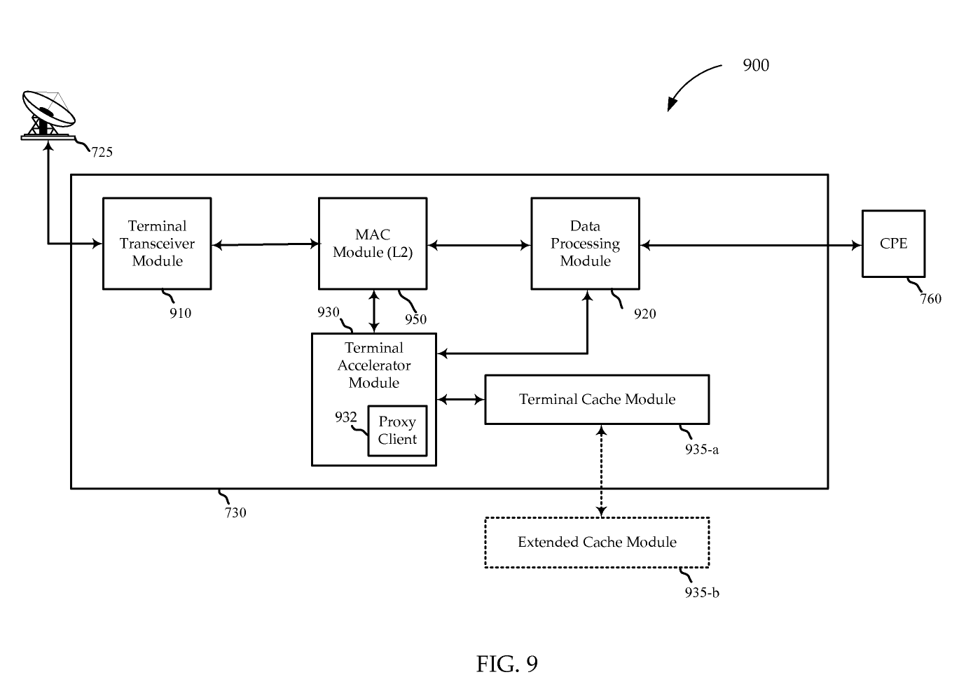

FIG. 9 shows a simplified block diagram 900 illustrating an embodiment of a subscriber terminal 730 coupled between the respective subscriber antenna 725 and the CPE 760, according to various embodiments of the invention. The subscriber terminal 730 includes a terminal transceiver module 910, a data processing module 920, a terminal accelerator module 930, a terminal cache module 935, and a MAC module 950. The components may be implemented, in whole or in part, in hardware. Thus, they may comprise one, or more, Application Specific Integrated Circuits (“ASICs”) adapted to perform a subset of the applicable functions in hardware. Alternatively, the functions may be performed by one or more other processing modules (or cores), on one or more integrated circuits. In other embodiments, other types of integrated circuits may be used (e.g., Structured/Platform ASICs, Field Programmable Gate Arrays (“FPGAs”) and other Semi-Custom ICs), which may be programmed in any manner known in the art. Each may also be implemented, in whole or in part, with instructions embodied in a computer-readable medium, formatted to be executed by one or more general or application specific processors.

A signal from the subscriber antenna 725 is received by the subscriber terminal 730 at the terminal transceiver module 910. Embodiments of the terminal transceiver module 910 may amplify the signal, acquire the carrier, and/or downconvert the signal. In some embodiments, this functionality is performed by other components (either inside or outside the subscriber terminal 730). The downconverted signal is communicated to the data processing module 920 to be digitized and further processed.

Embodiments of the data processing module 920 provide various types of data processing functionality. For example, the data processing module 920 processes the received signal by interpreting (e.g., and decoding) modulation and/or coding schemes, interpreting multiplexed data streams, filtering the digitized signal, parsing the digitized signal into various types of information (e.g., by extracting the physical layer header), etc.

In some embodiments, the data processing module 920 is in communication with the terminal accelerator module 930. In some embodiments, the terminal accelerator module 930 provides substantially the same functionality as the gateway accelerator module 950, including various types of applications, WAN/LAN, and/or other acceleration functionality. In one embodiment, the terminal accelerator module 930 implements functionality of AcceleNet applications, like interpreting data communicated by the gateway 715 using high payload compression, handling various prefetching functions, parsing scripts to interpret requests, etc. In certain embodiments, these and/or other functions of the terminal accelerator module 930 are provided by a proxy client 932 resident on (e.g., or in communication with) the terminal accelerator module 930.

In some embodiments, output from the data processing module 920 and/or the terminal accelerator module 930 is stored in the terminal cache module 935. Further, the data processing module 920 and/or the terminal accelerator module 930 may be configured to determine what data should be stored in the terminal cache module 935 and which data should not (e.g., which data should be passed to the CPE 760). It will be appreciated that the terminal cache module 935 may include any useful type of memory store for various types of functionality of the subscriber terminal 730. For example, the terminal cache module 935 may include volatile or non-volatile storage, servers, files, queues, etc.

In certain embodiments, storage functionality and/or capacity is shared between an integrated (e.g., on-board) terminal cache module 935-a and an extended (e.g., off-board) cache module 935-b. For example, the extended cache module 935-b may be implemented in various ways, including as an attached peripheral device (e.g., a thumb drive, USB hard drive, etc.), a wireless peripheral device (e.g., a wireless hard drive), a networked peripheral device (e.g., a networked server), etc. In one embodiment, functionality of the terminal cache module 935 is implemented as storage integrated in the CPE 760 of FIG. 7.

Data destined for the CPE 760 (e.g., data not stored in the terminal cache module 935 or data retrieved from the terminal cache module 935) is communicated to the MAC module 950. Embodiments of the MAC module 950 prepare data for communication to the CPE 760. For example, the MAC module 950 may modulate, encode, filter, decrypt, and/or otherwise process the data to be compatible with the CPE 760.

In certain embodiments, the subscriber terminal 730 is configured to transmit data back to the gateway 715. Embodiments of the terminal transceiver module 910, the data processing module 920, the terminal accelerator module 930, the terminal cache module 935, and/or the MAC module 950 are configured to provide functionality for communicating information back through the satellite communication system 700 (e.g., for directing provision of services). For example, information about what is stored in the terminal cache module 835 may be sent back to the gateway 715 for limiting repetitious file transfers, as described more fully below.

It will be appreciated that the satellite communications system 700 may be used to provide different types of communication services to subscribers. For example, the satellite communications system 700 may provide content from the network 720 to a subscriber's CPE 760, including Internet content, broadcast television and radio content, on-demand content, voice-over-Internet-protocol (“VoIP”) content, and/or any other type of desired content. It will be further appreciated that this content may be communicated to subscribers in different ways, including through unicast, multicast, broadcast, and/or other communications.

Embodiments of the invention include methods, systems, and devices that use multicasting, caching, and/or other techniques to provide novel satellite communication functionality. It will be appreciated that other components and systems may be used to provide functionality of the various embodiments described herein. As such, descriptions of various embodiments in the context of components and functionality of FIGS. 7-9 are intended only for clarity, and should not be construed as limiting the scope of the invention.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of implementing a secure neighbor cache preload, the method comprising:
initiating, at a client system within a local area network (LAN) which includes a plurality of clients, a data transfer request, wherein the data transfer request is associated with a sequence of bytes;
receiving, at the client system from a content server via a proxy server, the sequences of bytes associated with the data transfer request;
storing the sequence of bytes in the client system's personal cache;
processing the data transfer request through a filtering system, wherein the filtering system is configured to determine whether the sequence of bytes is to be relayed to the plurality of clients;
based on the data transfer request passing through the filtering system, echoing, at the client system, the sequence of bytes to the plurality of client systems within the LAN using an Internet protocol (IP) broadcast operation; and
storing within each of the plurality of client systems' public caches at least a portion of the relayed sequence of bytes associated with the data transfer request.

2. A method implementing a secure neighbor cache preload as recited in claim 1, further comprising one or more of the client systems receiving, from the proxy server, an encryption key.

3. A method implementing a secure neighbor cache preload as recited in claim 2, further comprising:
encrypting, by the proxy server, the sequence of bytes; and
decrypting, by one or more of the plurality of clients using the encryption key, the sequence of bytes.

4. A method implementing a secure neighbor cache preload as recited in claim 1, further comprising:
initiating, at one of the plurality of client systems, a subsequent data transfer request, wherein the subsequent data transfer request is for the same sequence of bytes as the data transfer request; and
determining if the one of the plurality of client systems has stored in the shared byte cache at least a portion of a sequence of bytes associated with the subsequent data transfer request.

5. A method implementing a secure neighbor cache preload as recited in claim 4, further comprising in response to the one of the plurality of client systems having at least a portion of the sequence of bytes stored in the shared byte cache, retrieving the sequence of bytes from the one of the plurality of client system's shared byte cache.

6. A method implementing a secure neighbor cache preload as recited in claim 1, wherein echoing comprises multicasting or broadcasting.

7. A method implementing a secure neighbor cache preload as recited in claim 1, further comprising processing the data transfer through a filtering system.

8. A method implementing a secure neighbor cache preload as recited in claim 7, wherein the filtering system filters data based in part in one or more of the following factors: an associated application, an application type, a process type, a protocol, a destination port, a destination IP address, a host name, and encryption status of the data.

9. A method implementing a secure neighbor cache preload as recited in claim 8, further comprising determining, based in part one or more of the factors, that at least a portion of the data from the data transfer is to be filtered out.

10. A method implementing a secure neighbor cache preload as recited in claim 1, further comprising:
maintaining a history of the client system's personal cache; and
maintaining a history of each of the plurality of client systems' personal byte caches.

11. A method implementing a secure neighbor cache preload as recited in claim 1, wherein data stored with in the client system's personal cache is given a higher priority than data stored in the client system's public cache.

12. A system for implementing a secure neighbor cache preload, the system comprising:
a content server configured to transfer a sequence of bytes associated with a data transfer request;
a proxy server coupled with the content server, the proxy server configured to retrieve the sequence of bytes associated with the data transfer request, and forward the sequence of bytes;
a client system coupled with the proxy server, the client system configured to receive the sequence of bytes associated with the data transfer request from the proxy server, process the sequence of bytes through a filtering system, wherein the filtering system is configured to determine whether the sequence of bytes from the data transfer request are to be relayed, based on the data transfer request passing through the filtering system, relay the sequence of bytes from the data transfer request using an Internet protocol (IP) broadcast operation; and
a plurality of client systems coupled with the client system each having a shared cache, the plurality of client systems configured to receive the relayed sequence of bytes from the client system, and store at least a portion of the relayed sequence of bytes in the shared caches.

13. A system for implementing a secure neighbor cache preload as recited in claim 12, wherein the proxy server is comprised in a gateway.

14. A system for implementing a secure neighbor cache preload as recited in claim 13, wherein the client system is includes in a customer premises system.

15. A system for implementing a secure neighbor cache preload as recited in claim 14, wherein the customer premises system is in communication with a subscriber terminal.

16. A system for implementing a secure neighbor cache preload as recited in claim 15, wherein the gateway and the subscriber termination are in communication via a satellite.

17. A machine-readable medium having sets of instructions stored thereon which, when executed by a machine, cause the machine to:
initiating, at a client system within a local area network (LAN) which includes a plurality of clients, a data transfer request, wherein the data transfer request is associated with a sequence of bytes;
receive, at the client system from a content server via a proxy server, the sequences of bytes associated with the data transfer request;
store the sequence of bytes in the client system's personal cache;
process the data transfer request through a filtering system, wherein the filtering system is configured to determine whether the sequence of bytes is to be relayed to the plurality of clients;
based on the data transfer request passing through the filtering system, relay, at the client system, the sequence of bytes to the plurality of client systems within the LAN using an Internet protocol (IP) broadcast operation; and
store within each of the plurality of client systems' public caches at least a portion of the relayed sequence of bytes associated with the data transfer request.

18. The machine-readable medium of claim 17, wherein the sets of instructions which, when further executed by the machine, cause the machine to:
initiate, at one of the plurality of client systems, a subsequent data transfer request, wherein the subsequent data transfer request is for the same sequence of bytes as the data transfer request; and
determine if the one of the plurality of client systems has stored in the shared byte cache at least a portion of a sequence of bytes associated with the subsequent data transfer request.

19. The machine-readable medium of claim 18, wherein the sets of instructions which, when further executed by the machine, cause the machine to in response to the one of the plurality of client systems having at least a portion of the sequence of bytes stored in the shared byte cache, retrieve the sequence of bytes from the one of the plurality of client system's shared byte cache.

20. The machine-readable medium of claim 17, wherein the sets of instructions which, when further executed by the machine, cause the machine to process the data transfer through a filtering system.

21. The machine-readable medium of claim 20, wherein the filtering system filters data based in part in one or more of the following factors: an associated application, an application type, a process type, a protocol, a destination port, a destination IP address, a host name, and encryption status of the data.
